(19) United States
(12) Patent Application Publication
(10) Pub. No.: US 2021/0164140 A1
(43) Pub. Date: Jun. 3, 2021

(54) THERMAL INSULATION FLOCCULUS MATERIAL, PREPARATION METHOD THEREOF, AND THERMAL INSULATION ARTICLE

(71) Applicant: 3M INNOVATIVE PROPERTIES COMPANY, St. Paul, MN (US)

(72) Inventor: Weili Hu, Shanghai (CN)

(21) Appl. No.: 15/734,756

(22) PCT Filed: Jun. 10, 2019
(86) PCT No.: PCT/IB2019/054832

§ 371 Date: Dec. 3, 2020

(30) Foreign Application Priority Data
Jun. 14, 2018 (CN) 201810613878.0
Jun. 14, 2018 (CN) 201820922116.4

(51) Int. Cl. D04H 1/559; D04H 1/542

(52) U.S. Cl. CPC D04H 1/559; D10B 2401/04; D10B 2401/021; D04H 1/542

(57) ABSTRACT

The present invention provides a thermal insulation flocculus material, including a first outer layer and a base layer, the first outer layer being placed on a first surface of the base layer, wherein the first outer layer comprises a multi-layered single web, and the multi-layered single web comprises 15-30% of a synthetic fiber material with 0.2-2 Denier fineness; a water repellent treatment is previously performed on the synthetic fiber material with 0.2-2 Denier fineness; and the water repellent treatment is not performed on the rest of the components, the rest of the components comprising 45-75% of a synthetic fiber material with 0.2-4 Denier fineness and 10-25% of a low melting point fiber material with 1.5-5 Denier fineness; and the base layer is substantially composed of a fiber raw material on which the water repellent treatment is not performed. The thermal insulation flocculus material provided by the present invention possesses good water repellency, and has minimal effect on the overall thickness and compression resilience of the flocculus material. The method allows for effective control of material costs, and averts an increase in difficulty in the operational process.

### TECHNICAL FIELD

The present invention relates to the field of thermal insulation flocculus materials. More specifically, the present invention relates to improving moisture resistance and water repellency of a thermal insulation flocculus material.

### BACKGROUND

Thermal insulation filling materials are widely used in the production of various cold-proof products and winter gears, such as cold weather clothing, shoes, gloves, sleeping bags, and home textiles. These products are designed to provide warmth by forming a layer of air around the body. In addition to considering the thermal insulation performance of a product in dryness, it should be noted that when faced in conditions such as low temperatures, high humidity, or rain/fog, it is necessary for the product to possess good water repellency so as to promote comfort for the wearer. Common thermal insulation materials that are commercially available include: natural flocculus, such as cotton, wool, hemp, silk, kapok, bamboo fiber, down, etc.; and synthetic fiber flocculus, such as polyester, nylon, acrylic, polypropylene, polylactic acid fiber, cellulose fiber, etc.

Natural flocculus materials, such as cotton, wool, and down, have poor thermal insulation performance under high humidity or rain and fog due to their high moisture regain rates. Although synthetic fiber generally has a relatively low moisture absorption rate, moisture or water droplets can still permeate into the flocculus due to the porous fluffy structure of the nonwoven material, thereby affecting the warm-keeping performance of the material.

Therefore, there is a need in the art for the development of an outdoor thermal-insulating flocculus material that can be used in low temperature, high humidity, and rain/fog conditions. The material has to provide excellent thermal insulation, and at the meantime, providing excellent air permeability and water repellency to the flocculus material. The flocculus material itself is required to be capable of withstanding a certain hydrostatic pressure, so as to provide an enhanced solution for users in cold and humid environments.

A number of solutions are known to provide textiles or nonwoven material with water repellency, which will be described in the following examples.

The first type of solution involves laminating a layer of functional material on a nonwoven material to provide protection, water resistance, and the like, as recorded in WO 2011019478 A1 (Patent Document 1) and US 2010009112 A1 (Patent Document 2).

WO 2011019478 A1 (Patent Document 1) provides a laminate for protective clothing. In one embodiment, the laminate includes at least one nonwoven layer and an air permeable film layer bonded to the nonwoven layer. The air permeable membrane layer includes first and second microporous membrane layers and an inner monolithic (non-porous) layer between the first and second microporous membrane layers.

US 2010009112 A1 (Patent Document 2) discloses a waterproof/breathable moisture transfer liner, including a lining, for use in hiking, skiing, and backpacking. A series of layers, including a foam material and an isolated nonwoven layer, are provided on the exterior of the inner lining.

The second type of solution relates to a method of impregnating a fabric with a treatment liquid to impart water repellency thereto, such as JPH08246347 (Patent Document 3). Patent Document 3 teaches that, by immersing a synthetic fiber structure in a treatment liquid containing a fixing agent for tannic acid and an acid dye and then dissolving it in an organic solvent fluorine-based resin, water repellency with good washability is imparted to the fiber while the tactile texture of the fiber is maintained. The process includes: immersing a synthetic fiber structure such as a woven fabric, a knitted fabric or a nonwoven fabric in a treatment liquid containing a fixing agent for tannic acid and an acid dye (a fixing agent for an acid dye, etc.), and applying an aqueous dispersion of a fluorine-based resin; further coating a solution of a fluorine-based resin in an organic solvent, and drying the resulting synthetic fiber structure.

The third type of solution relates to a method of treating fibers with water repellency and then forming a nonwoven material, such as U.S. Pat. No. 5,770,308 (Patent Document 4) and CN1136613A (Patent Document 5).

U.S. Pat. No. 5,770,308 (Patent Document 4) discloses a highly hydrophobic fiber comprising a thermoplastic resin, wherein the following components are adhered to the fiber: (A), 75-90% by weight; (B), 5-20% by weight; and (C), 1-5% by weight, where (A) is a mixture comprising less than 55% by weight of at least one metal alkyl phosphate of 14 to 18 carbon atoms, and 45% by weight or more of at least one metal alkyl phosphate of 20 to 24 carbons salt; (B) is a compound containing a perfluoroalkyl group; and, (C) a metal alkyl phosphate of 2 to 6 carbon atoms. The fiber has antistatic properties and water repellency, and the resulting nonwoven material is used for an anti-leakage material or a water-impermeable sanitary material sheet.

CN1136613A (Document 5) discloses a hydrophobic fiber of a thermoplastic resin. The disclosure provides a special textile oil for the fiber surface to provide water repellency, processability and antistatic properties, and is applicable to be used as a surface material of nonwoven fabrics and sanitary napkins.

Regarding the first treatment, which is a method of laminating other layers on a nonwoven material, such a method increases the weight of the insulation material. In addition, the lamination process can have a negative impact on the thickness of the material by reducing the thickness. Such an impact is disadvantageous to the design and application of the thermal insulation flocculus material, and also affects the thermal insulation performance.

Regarding the second treatment, which involves impregnation with a treatment liquid, such a method requires a large amount of treatment liquid, and also reduces the thickness of the material. Likewise, such an impact is disadvantageous to the design of the thermal insulation flocculus material as well as the thermal insulation performance.

Regarding the third treatment, in the prior art, a water-repellent fiber is used to form a water-repellent non-woven material. Such a method usually utilizes a large amount of water-repellent fiber to achieve water-repellent properties in the nonwoven material. Manufacturing costs increase as a result, in addition to the increase in processing difficulty due to the presence of the large amount of water-repellent fiber.

Further, in the above conventional techniques, various treatments are not directed to the treatment of thermal insulation flocculus material. When improving water repellency in thermal insulation flocculus material, it is desirable that compression resilience and thermal insulation properties of the flocculus material are maintained. When the material is applied to cold weather clothing, it is desired that the material would meet users' needs articularly in cold and humid environments, thereby improving the performance of the product. There is still an urgent need for further improvements in this field. Further, in other applications, such as insulative bags, the present invention helps to reduce raw material costs and improve the performance of the product.

### SUMMARY

The technical problem to be solved by the present invention is to improve the water repellency of thermal insulation flocculus material while minimizing the negative impact on the compression resilience and thermal insulation, so as to meet end user's needs in cold and humid environments. In addition, the present invention aims to obtain economical, operable and processable results in terms of material selection and processing.

To achieve the above objects and solve the technical problem of the present invention, the present invention proposes a new concept. Regarding the flocculus material, the present invention provides a design of a configuration having different layers, wherein at least one outer layer has water repellency, and the outer layer has a multi-layered single web structure. The fiber in the multi-layered single web includes a proportion of finer fiber previously having water repellent treatment performed thereon, a proportion of other fiber not having water repellent treatment performed thereon, and a proportion of low-melting point fiber materials. Such a multi-layered single web structure covers the base layer of the flocculus material. In particular, the water repellent material can be omitted in the base layer of the flocculus material. Alternatively, the water repellent treatment can be omitted.

The flocculus material of the present invention is lapped; and after the heat treatment, the low melting point fiber is appropriately melted to join the fibrous webs. A certain proportion of water-repellent fiber is present in the outer layer, and these water-repellent treated fine fiber forms a water-repellent web with an appropriate density, which possess unexpectedly good water repellency. At the same time, variations in the overall thickness and rebound resilience of the flocculus material of the article of the invention are limited by the use of a suitable proportion of water-repellent fiber in the surface layer, and without the need for a lamination process and subsequent addition of a water repellent impregnation.

Additionally, it is well known in the art that water-repellent fibers tend to accumulate static electricity, and thus are easily deposited on equipment for producing a nonwoven material, such as a comb and a roller or a guide roller, thereby reducing workability. The present invention can use a smaller proportion of water-repellent material in the processing, and the water-repellent material is only disposed in the surface layer of the flocculus material, and has no influence on a large proportion of the base layer. Therefore, not only the loss of processing performance is small, but also the material cost is significantly reduced.

The flocculus material of the present invention may be provided with only one water-repellent outer layer disposed on the side of the article such as clothing near the environment (outside, or away from the body side). Further, the flocculus material of the present invention may provide two water repellent outer layers, i.e., the water repellent multi-layered fibrous web is provided inside and outside the flocculus material, and the water repellent fiber is not added only in the base layer. Therefore, it is easy to provide more flexible material selection and fiber morphology design for the base layer. Therefore, the present invention includes the following technical solutions.

A first aspect of the present invention provides a thermal insulation flocculus material, including: a first outer layer; and a base layer, where the first outer layer is placed on a first surface of the base layer; the first outer layer includes a multi-layered single web, and the multi-layered single web includes 15-30% of a synthetic fiber material with 0.2-2 Denier fineness; a water repellent treatment is previously performed on the synthetic fiber material with 0.2-2 Denier fineness, and the water repellent treatment is not performed on the rest of the components, which includes 45-75% of a synthetic fiber material with 0.2-4 Denier fineness and 10-25% of a low melting point fiber material with 1.5-5 Denier fineness; and the base layer is substantially composed of a fiber raw material on which the water repellent treatment is not performed.

A second aspect of the present invention provides a method for manufacturing a thermal insulation flocculus material, including: forming a first outer layer including a multi-layered single web, where the multi-layered single web includes 15-30% of a synthetic fiber material with 0.2-2 Denier fineness, a water repellent treatment is previously performed on the synthetic fiber material with 0.2-2 Denier fineness, and the water repellent treatment is not performed on the rest of the components, which includes 45-75% of a synthetic fiber material with 0.2-4 Denier fineness and 10-25% of a low melting point fiber material with 1.5-5 Denier fineness; and forming a base layer on the first outer layer, so as to make a first surface of the base layer adjacent to the first outer layer, and the base layer is substantially composed of a fiber material on which the water repellent treatment is not performed.

A third aspect of the present invention provides a thermal insulation article, including a wrapping body, where the wrapping body is configured to wrap the thermal insulation flocculus material.

The thermal insulation flocculus material provided by the present invention has good water repellency, thereby minimizing the adverse effect on the overall thickness and resilience of the flocculus material. In addition, material costs are effectively controlled and an increase in processing difficulty is averted.

The thermal insulation flocculus material manufactured by using the method of the invention possess excellent water repellency, resilience, and thermal insulation performance. The application thereof in outdoor clothing shoes, hats, sleeping bags, etc. can improve user experience and, at the same time, reduce production cost.

### BRIEF DESCRIPTION OF THE DRAWINGS

FIG. 1 is a schematic perspective view showing the structure of a thermal insulation flocculus material according to an embodiment of the present invention;

FIG. 2 is a schematic view showing a preparation process of a thermal insulation flocculus material according to an embodiment of the present invention;

FIG. 3 is a comparison diagram of hydrostatic pressure test results of the thermal insulation flocculus materials of the examples and comparative examples of the present invention;

FIG. 4 is a comparison diagram of test results of compression resilience ratio of the thermal insulation flocculus materials of the examples and comparative examples of the present invention; and

FIG. 5 is a comparison diagram of test results of thermal resistance (Clo) of the heat insulating flocculus materials of the examples and comparative examples of the present invention.

### DETAILED DESCRIPTION

In order to allow a person of skill in the art to better comprehend technical solutions of the present invention, the present invention is further described in detail below in combination with accompanying drawings and particular embodiments.

### Interpretation of Terms

In the present invention, the meanings of the following terms or descriptions are as follows:

The description of “A to B” or “between A and B” includes values of A and B, and any value greater than A and less than B. For example, “between 1 and 10” includes 1, 10, and any value greater than 1 and less than 10, e.g., 2, 3, 4, 5, 6, 7, 8, 9, 2.3, 3.516, 5.26, 7.1, and 9.999, etc.

A description of “A is approximately B”, “A is substantially B”, and “A is essentially B” means that A is generally consistent with feature B, but there is an inevitable fine difference between A and B, and the difference is very small relative to the scale of B. “Substance amount used” or “the ratio of substance amount used,” unless otherwise specified, refers to weights or ratios by weight for the amounts or ratios of the substance amounts used herein.

“Percentage by weight of A in B” means that A is a part of B, and refers to the percentage of the weight of A when the weight of B is taken as 100%.

“The ratio of the weight of A to B” means a ratio of the weight of A to the weight of B when A is a different component than B.

“Fiber” refers to a continuous or discontinuous filament having a much greater dimension in the length direction than in any other directions in the cross section.

“Fibrous single web” means a single layer of thin fibrous web.

“The multi-layered fibrous single web” includes a plurality of adjacent (with no other substances in between) fibrous single webs that are stacked together.

“Denier (D)” is the unit for fiber fineness, which represents the weight in grams per 9000 meters of fibers at a given moisture regain.

“Clo” value is a parameter for evaluating the thermal insulation performance of a material, which is actually a thermal resistance value. A greater thermal resistance value suggests a better thermal insulation performance. When a person sitting quietly or engaged in slight brain work (a calorific value at 209.2 kJ/m2·h) feels comfortable in the environment with the temperature being 21° C., the relative humidity less than 50%, and wind speed not greater than 0.1 m/s, the Clo value of clothes worn is set as 1.

### DETAILED DESCRIPTION

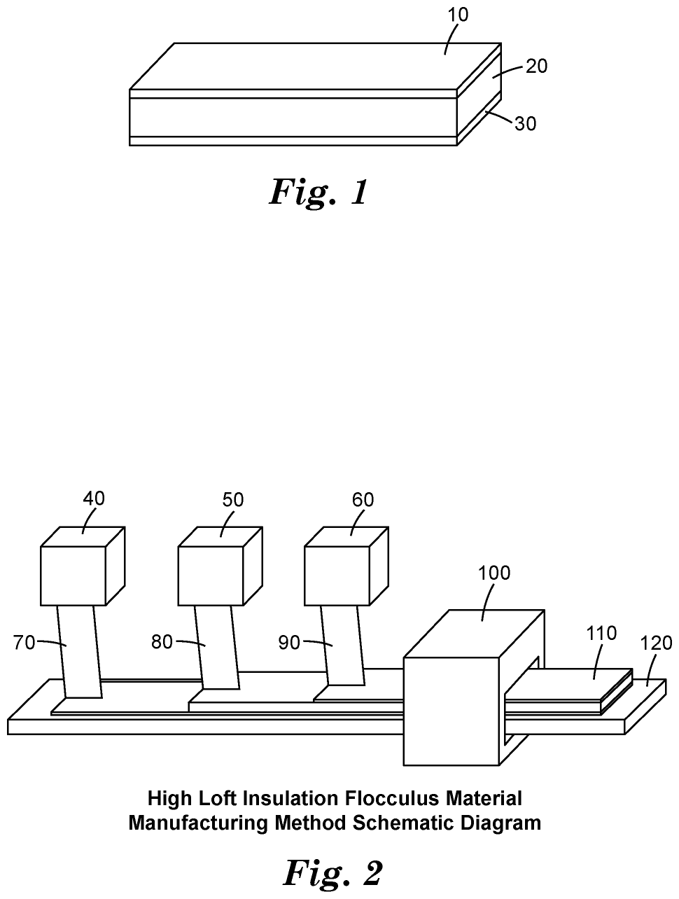

FIG. 1 shows an embodiment of the present invention, which provides a water-repellent high-resiliencethermal insulation filling material, including three different structural layers, that is, a first outer layer 10, a second outer layer 30, and a base layer (a medium layer) 20 placed between the first outer layer 10 and the second outer layer 30. The outer layers (the first outer layer 10 and the second outer layer 30) and the base layer 20 all include stacked multi-layered single webs.

In the two outer layers, the fiber raw materials selected for the multi-layer single web and the weight percentage thereof are: 15-30% of a raw or recycled synthetic water-repellent fiber material with 0.2-2 Denier fineness, 45-75% of a raw or recycled synthetic fiber material with 0.2-4 Denier fineness, and 10-25% of a raw or a recycled low melting point fiber material with 1.5-5 Denier fineness.

The base layer 20 is also composed of multi-layered single webs, and the selected fiber raw materials and the weight percentage thereof are: 0-45% of a raw or recycled synthetic fiber material with 0.2-2 Denier fineness, 30-95% of a raw or recycled synthetic fiber material with 2-15 Denier fineness, and 5-25% of a raw or a recycled low melting point fiber material with 1.5-7 Denier fineness. The base layer 20 does not need to be processed with the water repellent treatment.

The synthetic fiber may be a mixture of one or more of polyester fiber, polyamide fiber, polyvinyl chloride fiber, polyacrylonitrile fiber, polylactic acid fiber, and polypropylene fiber, and has a length of 15 to 75 mm.

The water-repellent fiber is a fiber that has undergone the water repellent treatment. The water repellent agent that is used in the water repellent treatment includes, but is not limited to, any one or more of an organic fluorine type water-repellent agent, a silicone type water-repellent agent, a silicon fluorine combination type water-repellent agent, and a hydrocarbon water-repellent agent.

Low melting point fibers include, but are not limited to, polyester low melting point fiber, polypropylene low melting point fiber, ethylene low melting point fiber, etc., and may be sheath core fiber, such as sheath core type polyester low melting point fiber. The low melting point fibers have a length of 20-90 mm and a melting point in the range of 100-140° C.

The single web in each of the multi-layered fibers has a grammage between 5 gsm and 50 gsm, preferably a grammage ranging from 10 gsm to 40 gsm.

In this embodiment, the multi-layered single web structure of the base layer 20 accounts for 20%-80% of the total weight of the flocculus material. The flocculus material as a whole has a grammage between 40 gsm and 600 gsm, preferably a grammage ranging from 60 gsm to 400 gsm.

An adhesive spraying treatment can be applied to the surface of the thermal insulation flocculus, which is also a common treatment process for the flocculus materials, generally in order to make the surface of the flocculus flatter. Alternatively, an adhesive spraying treatment may not be applied. The surface adhesive spraying treatment is to facilitate the shaping of the article, and generally the proportion of the adhesive in the finished article is small to minimize the influence on the performance of the thermal insulation flocculus.

### Preparing Method Implementation

The present invention provides a method for manufacturing a water-repellent high-resilience thermal insulation filling material. First, the fiber raw material is selected as described above.

In this embodiment, the outer layer multi-layered single web structure and the intermediate multi-layered single web structure can be formed by carding or air-laying by using conventional carding and laying equipment.

As shown in FIG. 2, it shows a schematic diagram of the preparation process of the thermal insulation flocculus material of the present invention.

In this embodiment, three carding cross-lapping machines are provided: a first carding cross-lapping machine 40, a second carding cross-lapping machine 50, and a third carding cross-lapping machine 60.

A first fiber mixture required to form the first outer layer 10 is fed and mixed in the first carding cross-lapping machine 40, and the weight percentage content is: 15-30% of a raw or recycled synthetic fiber material with 0.2-2 Denier fineness after the water repellent treatment, 45-75% of a raw or recycled synthetic fiber material with 0.2-4 Denier fineness, and 10-25% of a raw or a recycled low melting point fiber material with 1.5-5 Denier fineness. 2 to 20 layers of single-layer fibrous web are laid on a conveyor belt 120 to form a multi-layered outer web 70 of the first outer layer.

The multi-layered web 70 of the first outer layer is fed via a conveyor belt 120 to the second carding cross-lapping machine 50.

A second fiber mixture required to form the base layer 20 is fed and mixed in the second carding cross-lapping machine 50, and the weight percentage content is: 0-45% of a raw or recycled synthetic fiber material with 0.2-2 Denier fineness, 30-95% of a raw or recycled synthetic fiber material with 2-15 Denier fineness, and 5-25% of a raw or a recycled low melting point fiber material with 1.5-7 Denier fineness. On the conveyor belt 120, 4 to 30 layers of single-layer fibrous web are laid corresponding to the position at which the above-mentioned multi-layered fibrous web 70 is placed to form a multi-layered fibrous web 80 as the base layer 20.

The multi-layered web 70 and the multi-layered web 80, which are laid in sequence, are conveyed via a conveyor belt 120 to a third carding cross-lapping machine 60. In this embodiment, the third fiber mixture required to form the second outer layer 30 is input and mixed in the third carding cross-lapping machine 60, and the third fiber mixture is similar or identical to the first fiber mixture.

Each of the multi-layered fibrous single web has a grammage of from about 5 gsm to 50 gsm, and preferably from about 10 gsm to 40 gsm. The multi-layered single web structure of the base layer 20 accounts for 20% to 80% of the total weight.

After all the fibrous webs are laid, they are sent to the oven 100 via the conveyor belt 120 for heat setting and reinforcement, and the heat setting temperature is 120-180 degrees Celsius, and the treatment time is 5-15 minutes. Thereby, a layered multi-layered thermal insulation material is formed.

The overall weight of the thermal insulation material can be set according to the specific application, typically between about 40 grams per square meter and about 600 grams per square meter, more preferably between about 60 grams per square meter and 400 grams per square meter.

In addition, it is also possible to perform an adhesive spraying treatment on the surface of the thermal insulation material (thermal insulation flocculus). This adhesive spraying treatment is a common treatment process in the processing of flocculus materials, generally in order to make the surface of the flocculus flatter. Alternatively, the adhesive spraying treatment may not be applied. The adhesive spraying treatment is often performed before the heat setting reinforcement treatment.

The description of the specific embodiments and comparative examples is further provided below to facilitate those skilled in the art to implement the present invention and further understand the advantages of the invention. These examples and comparative examples do not constitute a limitation to the invention.

### Embodiment 1

5 kg of 3D*64 mm hollow crimp synthetic polyester fiber produced by the Yizheng company, 3 kg 1.2D*51 mm water-repellent polyester fiber produced by the Yizheng company, 2 kg 2D*51 mm low melting point polyester fiber produced by the Huviscompany are chosen and mixed-opened-carded-cross-lapped (Jiangsu Yingyang non-woven machinery scx26 bonded wadding production line), to form an outer multi-layered web structure having a grammage of 30 gsm (for the first outer layer 10 and/or the second outer layer 30). 5 kg of 3D*64 mm hollow crimp synthetic polyester fiber produced by the Yizheng company, 3 kg 1.2D*51 mm polyester fiber produced by the Yizheng company, 2 kg 2D*51 mm low melting point polyester fiber produced by the Huvis company are chosen and mixed-opened-carded-cross-lapped to form a multi-layered web structure of a medium layer having a grammage of 40 gsm (the base layer 20). By performing heat setting treatment by drying at 160° C. for 6-9 minutes, 100 gsm water-repellent high-resilience thermal insulation flocculus material is obtained.

### Embodiment 2

6 kg of 1.2D*51 mm synthetic polyester fiber produced by the Far Eastern company, 2 kg 0.8D*38 mm water-repellent polyester fiber produced by the Far Eastern company, 2 kg 2D*51 mm low melting point polyester fiber produced by the Huvis company are chosen and mixed-opened-carded-cross-lapped (Jiangsu Yingyang non-woven machinery scx26 bonded wadding production line), to form an outer multi-layered web structure having a grammage of 25 gsm (for the first outer layer 10 and/or the second outer layer 30). 5 kg of 7D*64 mm hollow crimp synthetic polyester fiber produced by the Yizheng company, 3 kg 1.2D*51 mm polyester fiber produced by the Yizheng company, 2 kg 2D*51 mm low melting point polyester fiber produced by the Huviscompany are chosen and mixed-opened-carded-cross-lapped, to form a multi-layered web structure of a medium layer having a grammage of 50 gsm (the base layer 20). By performing heat setting treatment by drying at 160° C. for 6-9 minutes, 100 gsm water-repellent high-resilience thermal insulation flocculus material is obtained.

### Embodiment 3

5.5 kg of 1.4D*51 mm synthetic polyester fiber produced by the Yizheng company, 2.5 kg 1.2D*51 mm water-repellent polyester fiber produced by the Yizheng company, 2 kg 2D*51 mm low melting point polyester fiber produced by the Huviscompany are chosen and mixed-opened-carded-cross-lapped (Jiangsu Yingyang non-woven machinery scx26 bonded wadding production line), to form an outer multi-layered web structure having a grammage of 20 gsm (for the first outer layer 10 and/or the second outer layer 30); 8 kg of 2D*51 mm hollow crimp synthetic polyester fiber produced by the Yizheng company, 2 kg 2D*51 mm low melting polyester fiber produced by the Huvis company are chosen and mixed-opened-carded-cross-lapped, to form a multi-layered web structure of a medium layer having a grammage of 60 gsm (the base layer 20). By performing heat setting treatment by drying at 160° C. for 6-9 minutes, 100 gsm water-repellent high-resilience thermal insulation flocculus material is obtained.

### Embodiment 4

5 kg of 1.2D*51 mm synthetic polyester fiber produced by the Far Eastern company, 3 kg 0.8D*51 mm water-repellent polyester fiber produced by the Far Eastern company, 2 kg 2D*51 mm low melting point polyester fiber produced by the Huvis company are chosen and mixed-opened-carded-cross-lapped (Jiangsu Yingyang non-woven machinery scx26 bonded wadding production line), to form an outer multi-layered web structure having a grammage of 20 gsm (for the first outer layer 10 and/or the second outer layer 30). 5 kg of 7D*64 mm hollow crimp synthetic polyester fiber produced by the Yizheng company, 3 kg 1.2D*51 mm polyester fiber produced by the Yizheng company, 2 kg 2D*51 mm low melting point polyester fiber produced by the Huvis company are chosen and mixed-opened-carded-cross-lapped, to form a multi-layered web structure of a medium layer having a grammage of 60 gsm (the base layer 20). The 6 gsm YH-1 type adhesive produced by Jindeli Chemical Co., Ltd. was sprayed on the outer surface of the material and the material was subjected to heat setting rtreatment by drying at 160° C. for 6-9 minutes to obtain 100 gsm water-repellent high-resilience thermal insulation flocculus material.

### Embodiment 5

6.5 kg of 0.8D*38 mm synthetic polyester fiber produced by the Far Eastern company, 1.5 kg 0.8D*38 mm water-repellent polyester fiber produced by the Far Eastern company, 2 kg 2D*51 mm low melting point polyester fiber produced by the Huvis company are chosen and mixed-opened-carded-cross-lapped (Jiangsu Yingyang non-woven machinery scx26 bonded wadding production line), to form an outer multi-layered web structure having a grammage of 30 gsm (for the first outer layer 10 and/or the second outer layer 30). 8 kg of 7D*64 mm hollow crimp synthetic polyester fiber produced by the Yizheng company, 2 kg 2D*51 mm low melting point polyester fiber produced by the Huvis company are chosen and mixed-opened-carded-cross-lapped, to form a multi-layered web structure of a medium layer having a grammage of 40 gsm (the base layer 20). The 6 gsm YH-1 type adhesive produced by Jindeli Chemical Co., Ltd. was sprayed on the outer surface of the material and the material was subjected to heat setting treatment by drying at 160° C. for 6-9 minutes to obtain 100 gsm water-repellent high-resilience thermal insulation flocculus material.

### Comparative Example 1

5 kg of 3D*64 mm hollow crimp synthetic polyester fiber produced by the Yizheng company, 3 kg 2D*51 mm polyester fiber produced by the Yizheng company, 2 kg 2D*51 mm low melting point polyester fiber produced by the Huvis company are chosen and mixed-opened-carded-cross-lapped (Jiangsu Yingyang non-woven machinery scx26 bonded wadding production line), to form a multi-layered web structure having a grammage of 100 gsm. By performing heat setting treatment by drying at 160° C. for 6-9 minutes, 100 gsm thermal insulation flocculus material was obtained.

### Comparative Example 2

2 kg of 3D*64 mm hollow crimp synthetic polyester fiber produced by the Yizheng company, 6 kg 1.2D*51 mm water-repellent polyester fiber produced by the Yizheng company, 2 kg 2D*51 mm low melting point polyester fiber produced by the Huvis company are chosen and mixed-opened-carded-cross-lapped (Jiangsu Yingyang non-woven machinery scx26 bonded wadding production line), to form a multi-layered web structure having a grammage of 100 gsm. By performing heat setting treatment by drying at 160° C. for 6-9 minutes, 100 gsm thermal insulation flocculus material was obtained.

### Main Performance Test

The samples of the above examples and comparative examples were tested, mainly including water repellency, compression resilience and thermal insulation, and the results are as follows:

### 1) Water Repellency

The hydrostatic resistance of the flocculus material was measured according to ISO 9073-16 (i.e., GB/T 24218.16). The sample was placed on a test head with a test area of (100±1) cm², and a continuously increasing water pressure was applied to the sample at a water pressure increase rate of (10±0.5) cm H2O/min, until the third water droplet appears on the surface of the nonwoven fabric and the hydrostatic pressure value at the third point of the water seepage point on the sample is taken.

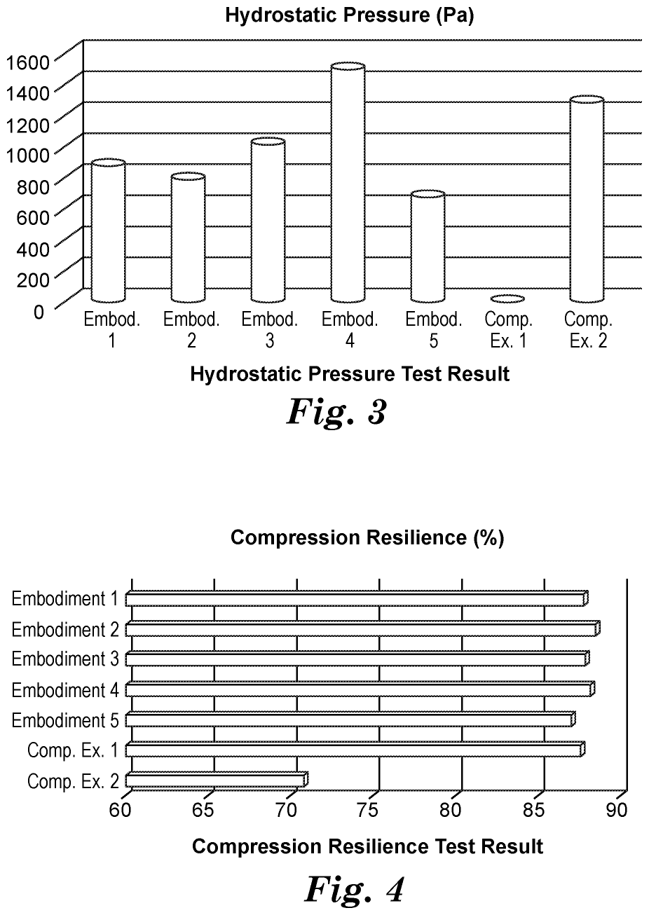

As shown in FIG. 3, the water pressure resistance of the samples of the examples was significantly better than that of the conventional flocculus materials.

In Comparative Example 1, the ordinary flocculus material has poor water permeability resistance, and the water droplets quickly penetrate into the flocculus material, thereby causing the flocculus material to have a lower thermal insulation performance.

The thermal insulation flocculus material of Embodiments 1-5 can withstand a certain hydrostatic pressure and maintain its original bulkiness and thermal insulation performance. This performance can show significant advantages in the outdoor high humidity and rain fog weather.

Although the material of Comparative Example 2 also has water repellency and is resistant to a certain hydrostatic pressure, its overall performance is not ideal due to its low thickness and poor thermal insulation performance.

Accordingly, the present invention provides a solution that does not require the use of a 100% (or a high proportion of) water-repellent fibers. Through the introduction of different structural layers, as well as the introduction of only a certain amount of water-repellent fine fiber material in the outer structural layer, the present invention provides a flocculus material with good overall water repellency while maintaining good resilience and thermal insulation performance of the flocculus material. When considering the possible reasons, without being limited to the theoretical realm, a possible reason is that the density of the flocculus material can be increased due to the presence of fine fibers in the outer layer. Furthermore, since the water repellent layer is formed on the surface of the fiber, and a water-repellent fibrous web composed of fine fibers is provided, thus achieving a desired hydrostatic resistance. In the intermediate layer (base layer), more choices are allowed, and other specific fiber materials and contents are introduced and controlled by design to achieve the overall performance required for the overall flocculus material.

### 2) Compression Resilience

The compression resilience of the sample was tested according to 6.10 in FZ/T64006.

The sample size was prepared to be 10 cm×10 cm, that is, the sample area S was 100 cm². The light pressure was set to 0.02 Kpa and the heavy pressure was set to 1 Kpa. Light pressure was applied; after 10 s, the initial thickness t0 (mm) was measured. The pressure was then increased to heavy pressure; after 1 minute, the thickness th (mm) was measured. The heavy pressure was removed; after 1 minute, light pressure was applied again. After 10 s, the recovery thickness tr (mm) was measured. The compression resilience ratio (%)=(tr−th)/(t0−th)×100.

FIG. 4 shows the results of the tests showing that the samples of Examples 1-5 have a high compression resilience comparable to conventional flocculus materials, significantly better than that of the flocculus materials of Comparative Example 2. The invention achieves excellent resilience performance through the design of different structural layers. The introduction of too many fine fibers in Comparative Example 2 reduces the compression resilience of the finished flocculus material to a certain extent, which adversely affects its thermal insulation performance.

### 3) Thermal Insulation

The sample was vacuum packed and placed for 2 weeks, and the package was opened and the article was placed under no pressure for at least 24 hours for recovery. The sample Clo value was tested according to GB/T 11048 (ASTMF 1868 Part C), and the test sample was 50 cm*50 cm, and the grammage was 100 gsm.

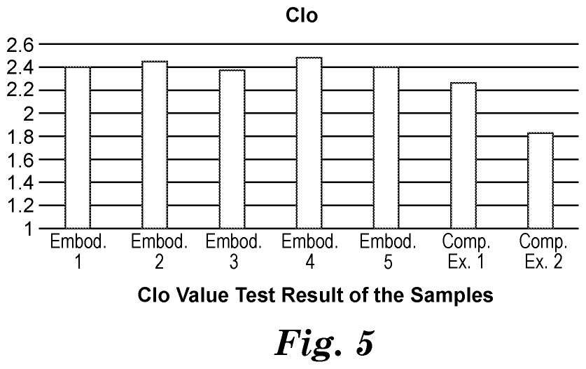

FIG. 5 is the test result of the sample Clo value, and it can be seen that the samples of Examples 1 to 5 of the present invention have good thermal insulation, and their thermal insulation values are higher than that of the samples of Comparative Example 2 with the same grammage. When the flocculus has a uniform structure and the content of the water-repellent fine fibers is too high, although a certain water-repellent property can be achieved, the resilience of the flocculus is reduced. As a result, the thermal insulation property of the material after compression is greatly compromised, making it difficult for the material to meet the requirements of high thermal insulation in cold environments.

The design of the different structural layers in the present invention contributes to provide water repellency while ensuring that much static air remains in the multi-layered web structure, thereby obtaining a thermal insulation flocculus material with high thermogravimetric efficiency.

### Variation Examples

In the above embodiments and examples, the first outer layer and the second outer layer having water repellency are respectively disposed on both sides of the base layer.

Depending on a specific application, it is also possible to provide only one outer layer with water repellency, the other outer layer may be omitted, or may have different properties, for example, the second outer layer is provided as an outer layer having heat reflecting properties. A separate water-repellent outer layer is placed on a side closer to the humidity source. In this case, the surface with moisture resistance can be marked on the surface of the thermal insulation flocculus material to facilitate subsequent processing.

The provision of a separate water-repellent outer layer further omits the introduction of water-repellent fibers and, in addition, provides more flexible design possibilities for different applications.

The present invention includes at least the following concepts:

Concept 1: A thermal insulation flocculus material, comprising a first outer layer; and a base layer, wherein the first outer layer is placed on a first surface of the base layer;

the first outer layer comprises a multi-layered single web, and the multi-layered single web includes 15-30% of a synthetic fiber material with 0.2-2 Denier fineness; a water repellent treatment is previously performed on the synthetic fiber material with 0.2-2 Denier fineness, and the water repellent treatment is not performed on the rest of the components, which comprises 45-75% of a synthetic fiber material with 0.2-4 Denier fineness and 10-25% of a low melting point fiber material with 1.5-5 Denier fineness; and

the base layer is substantially composed of a fiber raw material on which the water repellent treatment is not performed.

Concept 2: The thermal insulation flocculus material according to concept 1, further comprising a second outer layer, wherein the second outer layer is placed on a second surface of the base layer;

the second outer layer comprises a multi-layered single web, the multi-layered single web comprises 15-30% of a synthetic fiber material with 0.2-2 Denier fineness, a water repellent treatment is previously performed on the synthetic fiber material with 0.2-2 Denier fineness, and the water repellent treatment is not performed on the rest of the components, which comprises 45-75% of a synthetic fiber material with 0.2-4 Denier fineness and 10-25% of a low melting point fiber material with 1.5-5 Denier fineness.

Concept 3: The thermal insulation flocculus material according to concept 1 or 2, wherein the base layer comprises a multi-layered single web, and the weight percentage content of the selected fiber raw material is: 0-45% of a synthetic fiber material with 0.2-2 Denier fineness, 30-95% of a synthetic fiber material with 2-15 Denier fineness, and 5-25% of a low melting point fiber material with 1.5-7 Denier fineness.

Concept 4: The thermal insulation flocculus material according to concept 3, wherein the synthetic fiber is selected from: polyester fiber, polyamide fiber, polyvinyl chloride fiber, polyacrylonitrile fiber, polylactic acid fiber, polypropylene fiber, or a mixture of one or more of the above.

Concept 5: The thermal insulation flocculus material according to concept 4, wherein a length of the synthetic fiber is 15-75 mm.

Concept 6: The thermal insulation flocculus material according to any one of concepts 1 to 3, wherein the water repellent treatment comprises a fiber surface water repellent treatment, or a water repellent agent is added into the fiber, wherein the water repellent agent is any one or more selected from the group consisting of: an organic fluorine type water repellent agent, a silicone type water repellent agent, a silicon fluorine combination type water repellent agent, and a hydrocarbon water repellent agent.

Concept 7: The thermal insulation flocculus material according to any one of concepts 1 to 6, wherein each of the multi-layered fibrous single web has a grammage of from about 5 gsm to 50 gsm.

Concept 8: The thermal insulation flocculus material according to any one of concepts 1 to 6, wherein each of the multi-layered fibrous single web has a grammage of from about 10 gsm to 40 gsm.

Concept 9: The thermal insulation flocculus material according to any one of concepts 1 to 6, wherein the base layer accounts for 20% to 80% of the total weight.

Concept 10: The thermal insulation flocculus material according to any one of concepts 1 to 6, wherein the material as a whole has a grammage of between 40 gsm and 600 gsm.

Concept 11: The thermal insulation flocculus material according to any one of concepts 1 to 6, wherein the material as a whole has a grammage of between 60 gsm and 400 gsm.

Concept 12: The thermal insulation flocculus material according to concept 1, wherein a mark is set on the first outer layer or the second outer layer to indicate that the first outer layer comprises a synthetic fiber material on which the water repellent treatment is performed.

Concept 13: A method for manufacturing a thermal insulation flocculus material, comprising:

forming a first outer layer comprising a multi-layered single web, wherein the multi-layered single web comprises 15-30% of a synthetic fiber material with 0.2-2 Denier fineness, a water repellent treatment is previously performed on the synthetic fiber material with 0.2-2 Denier fineness, and the water repellent treatment is not performed on the rest of the components, which comprises 45-75% of a synthetic fiber material with 0.2-4 Denier fineness and 10-25% of a low melting point fiber material with 1.5-5 Denier fineness;

and forming a base layer on the first outer layer, so as to make a first surface of the base layer adjacent to the first outer layer, and the base layer is substantially composed of a fiber raw material on which the water repellent treatment is not performed.

Concept 14: The method for manufacturing a thermal insulation flocculus material according to concept 13, further comprising: forming a second outer layer comprising a multi-layered single web, wherein the multi-layered single web comprises 15-30% of a synthetic fiber material with 0.2-2 Denier fineness, a water repellent treatment is previously performed on the synthetic fiber material with 0.2-2 Denier fineness, and the water repellent treatment is not performed on the rest of the components, which comprises 45-75% of a synthetic fiber material with 0.2-4 Denier fineness and 10-25% of a low melting point fiber material with 1.5-5 Denier fineness; and the second outer layer is formed on a second surface of the base layer.

Concept 15: The method for manufacturing a thermal insulation flocculus material according to concept 13 or 14, further comprising performing an adhesive treatment on the surface of the thermal insulation flocculus material.

Concept 16: The method for manufacturing a thermal insulation flocculus material according to any one of concepts 13 to 15, further comprising performing heat setting treatment on the thermal insulation flocculus material.

Concept 17: A thermal insulation article, comprising:

a wrapping body, wherein the wrapping body is configured to wrap the thermal insulation flocculus material in any one of concepts 1 to 12.

Concept 18: The thermal insulation article according to concept 17, wherein the thermal insulation article is any one of a shoe, a hat, a garment, a pillow, a quilt, a mat, a sleeping bag, a thermal insulation bag, and a thermal insulation cover.

It can be understood that, the above embodiments are only exemplary embodiments employed for illustration of principles of the present invention, and do not limit the present invention. For those of ordinary skill in the art, various variations and modifications may be made without departing from the spirit and essence of the present invention, which variations and modifications are also considered as falling within the protection scope of the present invention.

1. A thermal insulation flocculus material, comprising a first outer layer and a base layer, the first outer layer being placed on a first surface of the base layer, wherein
the first outer layer comprises a multi-layered single web, and the multi-layered single web comprises 15-30% of a synthetic fiber material with 0.2-2 Denier fineness; a water repellent treatment is previously performed on the synthetic fiber material with 0.2-2 Denier fineness; the water repellent treatment is not performed on the rest of the components, the rest of the components comprising 45-75% of a synthetic fiber material with 0.2-4 Denier fineness and 10-25% of a low melting point fiber material with 1.5-5 Denier fineness; and
the base layer is substantially composed of a fiber raw material on which the water repellent treatment is not performed.

2. The thermal insulation flocculus material according to claim 1, further comprising a second outer layer, the second outer layer being placed on a second surface of the base layer, wherein:
the second outer layer comprises the multi-layered single web, and the multi-layered single web comprises 15-30% of a synthetic fiber material with 0.2-2 Denier fineness; a water repellent treatment is previously performed on the synthetic fiber material with 0.2-2 Denier fineness; the water repellent treatment is not performed on the rest of the components, the remaining components comprising 45-75% of a synthetic fiber material with 0.2-4 Denier fineness and 10-25% of a low melting point fiber material with 1.5-5 Denier fineness.

3. The thermal insulation flocculus material according to claim 1, wherein the base layer comprises the multi-layered single web, and the weight percentage content of the selected fiber raw material is: 0-45% of a synthetic fiber material with 0.2-2 Denier fineness; 30-95% of a synthetic fiber material with 2-15 Denier fineness; and 5-25% of a low melting point fiber material with 1.5-7 Denier fineness.

4. The thermal insulation flocculus material according to claim 3, wherein the synthetic fiber is selected from: polyester fiber, polyamide fiber, polyvinyl chloride fiber, polyacrylonitrile fiber, polylactic acid fiber, polypropylene fiber, or a mixture of one or more of the above.

5. The thermal insulation flocculus material according to claim 4, wherein a length of the synthetic fiber is 15-75 mm.

6. The thermal insulation flocculus material according to claim 1, wherein the water repellent treatment comprises a water repellent treatment on the fiber surface, or a water repellent agent added into the fiber, wherein the water repellent agent is any one or more selected from the group consisting of: an organic fluorine type water repellent agent, a silicone type water repellent agent, a silicon fluorine combination type water repellent agent, and a hydrocarbon water repellent agent.

7. The thermal insulation flocculus material according to claim 1, wherein each of the multi-layered fibrous single web has a grammage of from about 5 gsm to 50 gsm.

8. The thermal insulation flocculus material according to claim 1, wherein each of the multi-layered fibrous single web has a grammage of from about 10 gsm to 40 gsm.

9. The thermal insulation flocculus material according to claim 1, wherein the base layer accounts for 20% to 80% of the total weight.

10. The thermal insulation flocculus material according to claim 1, wherein the material as a whole has a grammage of between 40 gsm and 600 gsm.

11. The thermal insulation flocculus material according to claim 1, wherein the material as a whole has a grammage of between 60 gsm and 400 gsm.

12. The thermal insulation flocculus material according to claim 1, wherein a mark is disposed on the first outer layer or the second outer layer to indicate that the first outer layer comprises a synthetic fiber material on which a water repellent treatment is performed.

13. A method for manufacturing a thermal insulation flocculus material, comprising:
forming a first outer layer comprising a multi-layered single web, wherein the multi-layered single web comprises 15-30% of a synthetic fiber material with 0.2-2 Denier fineness; a water repellent treatment is previously performed on the synthetic fiber material with 0.2-2 Denier fineness; and the water repellent treatment is not performed on the rest of the components, the rest of the components comprising 45-75% of a synthetic fiber material with 0.2-4 Denier fineness and 10-25% of a low melting point fiber material with 1.5-5 Denier fineness;
and forming a base layer on the first outer layer, such that a first surface of the base layer is adjacent to the first outer layer, wherein the base layer is substantially composed of a fiber raw material on which the water repellent treatment is not performed.

14. The method for manufacturing a thermal insulation flocculus material according to claim 13, further comprising: forming a second outer layer comprising a multi-layered single web, wherein the multi-layered single web comprises 15-30% of a synthetic fiber material with 0.2-2 Denier fineness; a water repellent treatment is previously performed on the synthetic fiber material with 0.2-2 Denier fineness; and the water repellent treatment is not performed on the rest of the components, the rest of the components comprising 45-75% of a synthetic fiber material with 0.2-4 Denier fineness and 10-25% of a low melting point fiber material with 1.5-5 Denier fineness; and the second outer layer is formed on a second surface of the base layer.

15. The method for manufacturing a thermal insulation flocculus material according to claim 13, further comprising performing an adhesive treatment on a surface of the thermal insulation flocculus material.

16. The method for manufacturing a thermal insulation flocculus material according to claim 13, further comprising performing heat setting treatment on the thermal insulation flocculus material.

17. A thermal insulation article, comprising:
a wrapping body, wherein the wrapping body is configured to wrap the thermal insulation flocculus material in claim 1.

18. The thermal insulation article according to claim 17, wherein the thermal insulation article is any one of a shoe, a hat, a garment, a pillow, a quilt, a mat, a sleeping bag, a thermal insulation bag, and a thermal insulation cover.
